(19) United States
(12) Patent Application Publication
(10) Pub. No.: US 2023/0290538 A1
(43) Pub. Date: Sep. 14, 2023

(54) RF CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YU-YING WANG, Kunshan (CN); JUAN ZHENG, Kunshan (CN); LU-YU CHANG, New Taipei (TW)

(21) Appl. No.: 18/119,275

(22) Filed: Mar. 8, 2023

(30) Foreign Application Priority Data
Mar. 10, 2022 (CN) 202210228077.9

(51) Int. Cl. H01B 7/02; H01B 11/18; H01B 13/14

(52) U.S. Cl. CPC H01B 7/0275; H01B 11/1834; H01B 13/148

(57) ABSTRACT

An RF cable includes: an inner conductor; an insulating layer extrusion molded over the inner conductor; a shielding layer covering the insulating layer; and an outer coating layer covering the shielding layer, wherein plural air holes arranged at intervals on the insulating layer and the insulating layer is coated on the outer side of the inner conductor through one-time extrusion molding.

### BACKGROUND OF THE INVENTION

### Field of the Invention

The present invention relates to a cable, and more particularly to an RF cable used to transmit high-frequency signals.

### Description of Related Arts

U.S. Patent Application Publication No. 20050230145 discloses a signal transmission cable that comprises a central conductor, an insulated covering layer arranged on the outer periphery of the central conductor and having air gaps continuous along the longitudinal direction, and an outer conductor layer arranged on the outer periphery of the insulated covering layer. The insulated covering layer includes an inner annular portion covering the outer periphery of the central conductor, a plurality of coupling portions extending outward from the inner annular portion, and an outer annular portion connecting the outer peripheral edges of the coupling portions to each other. Air gaps defined along the peripheral direction by the coupling portions are formed on the inner side of the insulated covering layer. However, the structure and molding method of the above-mentioned insulating covering layer with air gaps are relatively complicated. Therefore, an improved radio frequency cable is needed to overcome the deficiencies of the prior art.

### SUMMARY OF THE INVENTION

A main object of the present invention is to provide an improved RF cable with good electrical performance and simple manufacturing process.

To achieve the above-mentioned object, an RF cable comprises: an inner conductor; an insulating layer extrusion molded over the inner conductor; a shielding layer covering the insulating layer; and an outer coating layer covering the shielding layer, wherein a plurality of air holes arranged at intervals on the insulating layer and the insulating layer is coated on the outer side of the inner conductor through one-time extrusion molding.

Compared to prior art, the lotus root-shaped structure of the cable insulation layer of the present invention is a one-time extrusion molding structure which has good electrical performance and is simple to manufacture.

### BRIEF DESCRIPTION OF DRAWINGS

FIG. 1 is a cross-sectional view of an RF cable of the present invention; and

FIG. 2 is a performance test curve view of the present invention and the traditional cable.

### DETAILED DESCRIPTION OF THE DRAWINGS

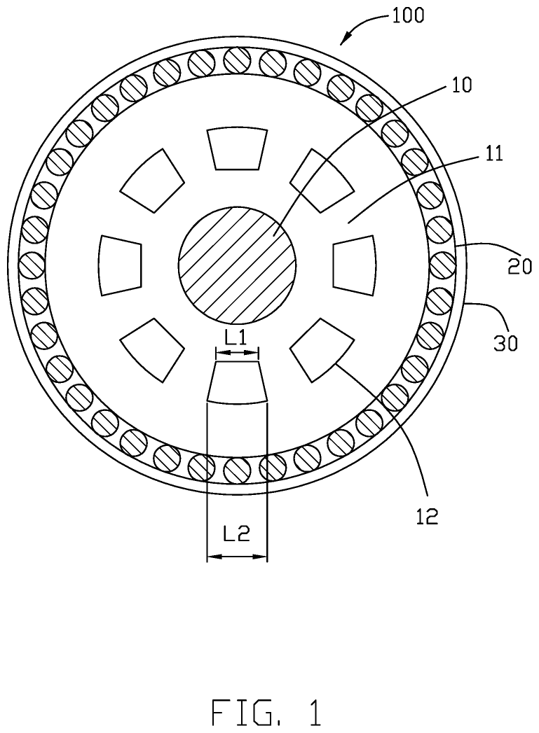

Referring to FIG. 1, it shows an RF cable 100 of the present invention. The RF cable 100 includes an inner conductor 10, an insulating layer 11 covering the inner conductor 10, a shielding layer 20 covering the insulating layer and the outer coating layer 30 covering the shielding layer 20.

The inner conductor 10 is a single or multiple stranded conductors. The inner conductor 10 is selected from the group consisting of copper wire, silver-plated copper wire, and tin-plated copper wire. The insulating layer 11 is coated on the outer side of the inner conductor through one extrusion molding. The insulating layer 11 includes a plurality of air holes 12 with air arranged at intervals, and the plurality of air holes 12 are located in the middle of the insulating layer 11 and distributed evenly around the outer periphery of the inner conductor 10. The air hole 12 is fan-shaped, the side length of one end adjacent to the inner conductor is L1, the arc length of the other end opposite to L1, that is, the end away from the inner conductor, is L2, and L1 is smaller than L2. In a cross section perpendicular to the extending direction of the RF cable 100, the areas of the plurality of air holes 12 are smaller than the remaining area of the insulating layer 11. In this embodiment, the number of the air holes is 8. It is worth noting that the insulating layer 11 is integrally extruded and formed, and its structure and manufacturing process are simple. The insulating layer 11 is selected from the group consisting of solid PE (polyethylene), solid PP (polypropylene), solid FEP (fluorinated ethylene propylene), foamed PE, foamed PP, and foamed FEP. The shielding layer 20 is a metal conductor shielding layer or a metal foil shielding layer. The metal conductor shielding layer is selected from the group consisting of copper, tin-plated copper and silver-plated copper. The metal foil shielding layer is selected from the group consisting of aluminum foil, double-layer aluminum foil, copper foil, double-layer copper foil, pure copper strip, pure aluminum strip, and semi-conductive strip. The shielding layer 20 covering the insulating layer 11 in a spiral winding or longitudinal coating manner. The outer coating layer 30 is covered with one or more layers of heat-sealable polyester tape outside the shielding layer, or through one or more layers of PE, or PP, or FEP extrusion molding outside the shielding layer.

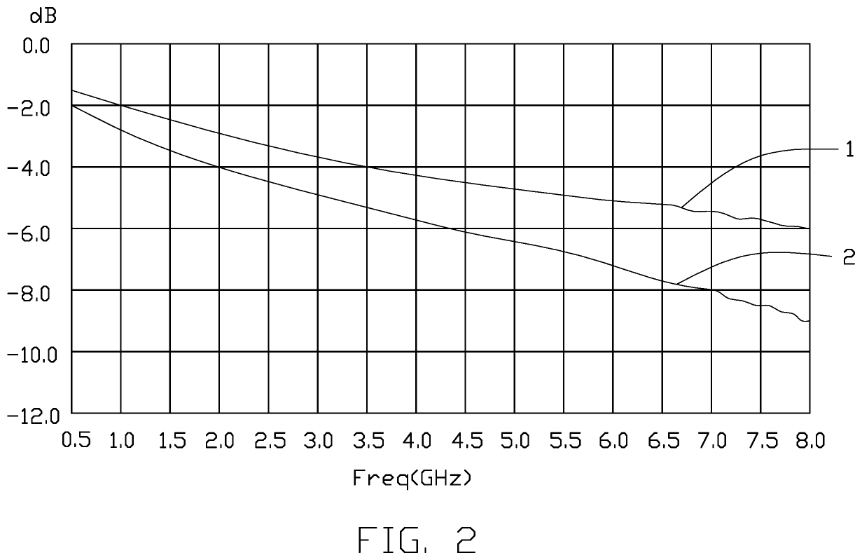

Referring to FIG. 2, it shows a performance test curve view of the present invention and the traditional cable. In order to facilitate observation, two test samples are the structure of the above-mentioned embodiment of the present invention and are American Wire Gauge 36AWG as sample, and the test curve of the cable whose insulating layer is a porous lotus root structure is recorded as curve 1, and the test curve of the cable whose insulating layer is a solid structure is recorded as curve 2. The abscissa is the frequency, the unit is GHz, and the ordinate is the loss, the unit is dB. It can be seen that as the frequency increases, the loss of the cable with the insulating layer of the porous lotus root structure is smaller than that of the cable with the solid insulating layer, and as the frequency increases, the gap between the two shows a gradually increasing trend.

1. An RF cable comprising:
an inner conductor;
an insulating layer extrusion molded over the inner conductor;
a shielding layer covering the insulating layer; and
an outer coating layer covering the shielding layer; wherein
a plurality of air holes are arranged at intervals on the insulating layer and the insulating layer is coated on the outer side of the inner conductor through one-time extrusion molding.

2. The RF cable as claimed in claim 1, wherein the plurality of air holes are located in the middle of the insulating layer and distributed evenly around the outer periphery of the inner conductor.

3. The RF cable as claimed in claim 1, wherein the insulating layer is selected from the group consisting of solid PE, solid PP, solid FEP, foamed PE, foamed PP, and foamed FEP.

4. The RF cable as claimed in claim 1, wherein the air holes are fan-shaped, and a side length of the hole adjacent to the inner conductor is smaller than an opposite arc length of the inner conductor.

5. The RF cable as claimed in claim 1, wherein in a cross section perpendicular to the extending direction of the RF cable, the areas of the plurality of holes are smaller than the remaining area of the insulating layer.

6. The RF cable as claimed in claim 1, wherein the inner conductor is a single or multiple stranded conductors.

7. The RF cable as claimed in claim 6, wherein the inner conductor is selected from the group consisting of copper wire, silver-plated copper wire, and tin-plated copper wire.

8. The RF cable as claimed in claim 1, wherein the outer coating layer comprises one or more layers, and its material is selected from the group consisting of heat-sealing polyester tape, polyethylene, polypropylene, and perfluoroethylene propylene copolymer.

9. The RF cable as claimed in claim 1, wherein the shielding layer covers the insulating layer in a spiral winding or longitudinal coating manner.

10. The RF cable as claimed in claim 1, wherein the shielding layer is a metal conductor shielding layer or a metal foil shielding layer.

11. The RF cable as claimed in claim 10, wherein the metal conductor shielding layer is selected from the group consisting of copper, tin-plated copper, and silver-plated copper, and the metal foil shielding layer is selected from the group consisting of aluminum foil, double-layer aluminum foil, copper foil, double-layer copper foil, pure copper strip, pure aluminum strip, and semi-conductive strip.
